(19) United States
(12) Patent Application Publication
(10) Pub. No.: US 2017/0134342 A1
(43) Pub. Date: May 11, 2017

(54) Data Network Of A Device, In Particular A Vehicle

(71) Applicant: SIEMENS AKTIENGESELLSCHAFT, MUENCHEN (DE)

(72) Inventors: RALF BEYER, MOEHRENDORF (DE); RAINER FALK, POING (DE)

(21) Appl. No.: 15/321,826

(22) PCT Filed: Jun. 25, 2015
(86) PCT No.: PCT/EP2015/064360

§ 371 Date: Dec. 23, 2016

(30) Foreign Application Priority Data
Jun. 27, 2014 (DE) 10 2014 212 484.0

(51) Int. Cl. H04L 29/06; H04L 12/46; H04L 12/42

(52) U.S. Cl. CPC H04L 63/0236; H04L 12/42; H04L 12/4641; H04L 12/4679; H04L 63/0263; H04L 63/08; H04L 2012/421; H04L 2012/40293

(57) ABSTRACT

A data network of a device, in particular a vehicle, has a set of device-internal nodes, at least one ring in which ring-internal nodes of the set are networked in a ring topology, and at least one interface unit for establishing a connection between at least one ring-external node and the ring. A generic data network has at least one ring and enables secure operation and simple management that can be used flexibly. The data network has a filtering device with at least one filter function, for filtering data traffic of the ring with respect to at least one node identifier, and an identification device for implementing at least one measure for a ring-external node, the measure relating to a node identifier of the node, such that the node identifier is permitted by the filter function for a data traffic in the ring.

The invention relates to a data network of a device, in particular a vehicle, having a set of intra-device nodes, at least one ring in which intra-ring nodes of the set are networked to one another in a ring topology, and at least one interface unit that is provided for the purpose of making a connection to the ring by at least one extra-ring node.

Data networks, in particular in rail vehicles, are known in which a ring topology is implemented in at least one network section. Nodes of the data network that are located outside the ring can communicate with further intra-ring or extra-ring nodes over at least part of the ring. For example, a network device such as a higher-level controller, or a controller for a device of the rail vehicle, for example for a brake or doors, can be linked into the ring by way of at least one switch. Using the OSI layer structure, these enable connectivity at layer 2 (e.g. Ethernet). A ring provides the advantage that if the ring is interrupted, for example in the event of its being broken because of a fire or a vehicle accident, communication continues to be possible over an undamaged ring section.

Besides these redundancy aspects, aspects in relation to data security (called “security”) and the protection of persons (called “safety”) are becoming ever more important. In particular, it should be possible to restrict the possibility of linking network devices into the ring for safety reasons. At the same time, however, it should also be possible, for example for the purpose of maintenance, to permit a maintenance device that is considered safe to be linked at least temporarily.

It is possible to provide a physical protection preventing access to a data network or network interface, for example by means of a lockable maintenance flap. Access to a data network may also be restricted by logical protection measures. A network access check may be performed in which a device connected to a network interface (also called a “port”) is identified and authenticated. Only if the connected device is recognized as permitted is the network interface activated. Examples are the network access control according to IEEE 802.1x or PANA according to RFC5191. As an alternative or in addition, a network device may generally be identified and authenticated using the MAC address or a password or indeed a device certificate (e.g. according to X.509).

In the case of authentication protocols of this kind, such as 802.1x, however, the starting point is a specific topology such as that conventional in fixed networks, for example in networks installed in a building. This topology is characterized by a structured cable layout in which a separate network connection is made from the access switch to each client. Here, an interface or port is enabled once a check has been made that it is in a protected environment. The known authentication protocols are thus not readily transferable to a ring topology.

As well as authentication measures, also known are so-called firewalls, or packet filters that filter the network traffic so that only traffic having permitted properties is allowed through.

The object of the invention is to provide a generic data network having at least one ring in which secure operation and simple management, in particular management that is flexible to use, can be achieved.

For this purpose, it is proposed that the data network should have a filtering device, which has at least one filter function and is provided for filtering data traffic in the ring for at least one node identifier, and an identification device which is provided for taking, for an extra-ring node, at least one measure relating to a node identifier of this node such that this identifier is permitted in respect of the filter function for data traffic in the ring. As a result, as well as a high level of security in operation of the data network, an advantageous flexibility in the management of the data network can be achieved, in particular as regards the linking of an extra-ring node. A measure relating to a node identifier is particularly straightforward to implement and perform.

The ring may in particular be used for real-time communication and/or safety-relevant communication. Here, conventionally there are restrictions on the security mechanisms that can be applied to the ring. For example, it may be that in some circumstances filter rules for the ring cannot be changed, or can be changed to only a limited extent. In an environment with this kind of use, a measure relating to a node identifier may be applied advantageously.

The term “intra-device” node should be understood in particular to mean a node of the data network that is provided, in respect of its type of construction and/or function, to be permanently linked to the device, in particular being mechanically linked. In particular, a specific location is provided in the device for installation of an intra-device node, wherein advantageously a fixing unit of the device serves to firmly link the node. The term “intra-ring” node of the data network should be understood to mean an intra-device node that is a constituent part of the ring, or that forms the ring with at least two further intra-device nodes. The term “extra-ring” node should be understood to mean a node of the data network that is connected outside the ring. An extra-ring node is also called an off-ring component in the art. An extra-ring node may be an intra-device node or a further node that is not permanently linked to the data network, in particular being occasionally linked thereto. A node of this kind is in particular called an extra-device node.

The term “making a connection” to the ring by an extra-ring node should be understood to mean a physical and/or logical connection. In particular, the interface unit may form a so-called port through which access to the ring may be provided for the extra-ring node.

The identification device and the interface unit may be formed at least partly, advantageously entirely from a common physical assembly. The interface unit and/or the identification device and at least one of the intra-ring nodes may be formed at least partly, advantageously entirely from a common physical assembly. To put it another way, the interface unit and/or the identification device may be formed at least partly, advantageously entirely from the advantageously cohesive assembly of an intra-ring node. The filtering device advantageously has at least one filter rule by which a node identifier is to be checked for a particular condition. A node identifier that is to be checked may be at least a constituent part of a source or destination address in a data packet that is provided for transmission over at least part of the ring. In a variant, a node identifier that is to be checked may be at least a constituent part of a virtual network identifier (or VLAN identifier). In a further variant, a node identifier that is to be checked may be a cryptographic check sum (for example message authentication code, message integrity code, digital signature). The condition is preferably defined using a data record that contains at least a list of node identifiers that are permitted for data traffic in the ring. A filter rule may for example be implemented such that a data packet is forwarded or blocked, depending on whether the condition relating to one or more node identifiers of the data packet is fulfilled or not.

The ring may enable unidirectional communication (for example only clockwise or counterclockwise) or bidirectional communication (in both orientations). With bidirectional communication, the ring may take the form of a double ring, in which case a first ring unit is provided for communication clockwise and a second ring unit is provided for communication in the opposite direction. In order to produce a communications network that has particularly high availability or fault tolerance, the ring itself may be constructed with redundancy. For example, the ring may have two ring units, it being possible to transmit data with redundancy on both ring units.

The ring topology may be physical and/or logical in form. For example, it is possible to produce the ring topology at least partly by means of a VLAN (or virtual local area network). It is possible to provide a plurality of physical ring units and/or a plurality of higher-level logical ring units.

The term data traffic “in the ring” should be understood to mean traffic of data over at least part of the ring—or a ring section. This may be data traffic between two intra-ring nodes, between an intra-ring node and at least one extra-ring node, or between two extra-ring nodes, wherein in this last case the data connection is made by way of at least one ring section.

The filtering device may be provided for filtering data traffic that is intended to be sent to the ring. This may be achieved in that the filtering device has at least one filter module that is assigned to the interface unit. As a result, the data traffic can be filtered before it is input to a ring section. To put it another way, filtering of the data traffic may take place outside the ring. Moreover, in this embodiment data traffic that originates in the ring and is directed toward at least one extra-ring node may be filtered. In a solution with a simple construction, the filter module may be coupled to the interface unit. Particularly advantageously, the interface unit and the filter module are formed by a common, cohesive assembly.

As an alternative or in addition, the filtering device may be provided for filtering data traffic that takes place over at least one ring section. For this purpose, it is proposed for the filtering device to have a set of filter modules, wherein at least one different filter module is assigned to each of the intra-ring nodes. This allows filtering of the data traffic that is performed within the ring to be achieved. Here, the filter modules are advantageously in each case provided for checking data traffic that comes over a ring section against at least one filter rule and where appropriate to forward it, for example to the next ring section, or to block it.

In this context, a compact embodiment that saves on components may be achieved if at least one different filter module is coupled to each of the intra-ring nodes. Particularly advantageously, a filter module and the assigned intra-ring node are formed by a common, cohesive assembly. To put it another way, the intra-ring nodes each have at least one filter module.

In an advantageous development of the invention, it is proposed that the filtering device should include at least one filter module that is equipped with at least one switch functionality, as a result of which particularly simple network management that may be implemented using widely available equipment can be achieved. Preferably, the filtering device has a set of filter modules that are each assigned to a different intra-ring node and are equipped with at least one switch functionality.

In an advantageous development of the invention, the intra-ring nodes each preferably take the form of a controller. Here, the controllers are each advantageously programmed for controlling at least one particular functionality of the device that differs from simply controlling data traffic in the data network. The controllers are advantageously each provided for controlling at least one sensor unit, one actuator unit and/or one lower-level control unit. Particularly advantageously, the controllers take the form of programmable logic controllers (or PLCs). For example, the intra-ring nodes may be formed by modules of the Simatic® type. Advantageously, one of the controllers may implement the function of a central controller of the device. The controllers may in particular themselves be provided with a switch functionality. This is particularly advantageous if a controller of the ring includes the interface unit and/or a filter module of the filtering device, or if a plurality of controllers of the ring each include an interface unit and/or a filter module of the filtering device.

In this context, the intra-ring nodes may be provided in particular for controlling a rail vehicle, a land-based vehicle or an aircraft. Here, conventionally there are particularly severe restrictions on the security mechanisms that can be used for the ring and in particular in the ring. For example, filter rules for the ring or in the ring cannot in some circumstances be changed, or can be changed only to a limited extent. It is advantageously possible to apply a measure in respect of a node identifier in an environment with this kind of use. This is particularly advantageous in the case of an embodiment of the device as a rail vehicle if the ring is used for real-time communication and/or for safety-relevant communication. Management of data traffic over the ring is in this case subject to stringent demands, with the result that security mechanisms that are conventional in other applications cannot readily be used. So-called safety requirements in the case of rail vehicles are defined in particular in standards EN 50128, 50159, 50126 and/or 50129. In particular, the safety requirements focus on the protection of persons, while the security requirements relate to general data security. The safety requirements are accordingly more stringent than the security requirements.

According to a preferred embodiment of the invention, it is proposed that the data network should include a network access control unit that is provided for management of data traffic access according to a defined authentication protocol, wherein the identification device is provided in at least one operating mode for taking the measure for an extra-ring node as a function of whether the latter is permitted by the network access control unit. As a result of this, the security of the management of data traffic in the data network can be further increased. The network access control unit is advantageously different, at least from a software point of view, from the filtering device. In particular, in the at least one operating mode a procedure is initiated for the measure taken by the identification device in respect of an extra-ring node only once a permission procedure of the network access control unit for this extra-ring node has been at least initiated and in particular concluded in a successful permission. The term “management” of the data traffic access should be understood to mean at least one procedure that includes permission or denial of access. This access may be access to the data network in general, but the network access control unit is advantageously provided for managing data traffic access to the ring in a targeted manner. Here, for an extra-ring node that is permitted access by the network access control unit, an interface or a port of the interface unit may for example be enabled. Here, the network access control unit may be called a “ring access control”.

Advantageously, a complex authentication of the extra-ring node that has to be administered is performed by the network access control unit, as a result of which the filtering device does not have to perform and check the authentication task itself. This is advantageous in particular if the filtering device includes filter modules that are formed by intra-ring nodes, since these filter modules and hence the assigned nodes of the ring do not take on the burden of this task.

Conceivable authentication protocols are various protocols that appear useful to those skilled in the art, such as a protocol according to 802.1x, PANA according to RFC 5191, EAP-TLS authentication by means of device certificate, or https with certificate-based authentication. In particular, the network access control unit can include a first unit and at least one authentication server, which is separate from the unit, and which checks the authentication of the extra-ring node to be given permission and provides the result of the authentication procedure to the unit. The authentication server may be a constituent part of the extra-ring node. As a further authentication protocol, a simple authentication based on the MAC address may be performed. As a further authentication method, an authentication by means of user name and password, or by means of an access code, may be performed. These may be input in an html form on a web page, for example. In a further variant, authentication may be performed by means of a physical access token, for example a mechanical key-operated switch or an RFID card reader.

In a variant, temporary enabling may be performed. Enabling of an extra-ring node may be ended among other things by log-off thereof (“EAPOL logoff”), a time-out criterion or by breaking the physical network connection of the extra-ring node with the data network.

If the network access control unit declines data traffic access for an extra-ring node, then data traffic in which this node takes part may be blocked by the network access control unit. As an alternative, the network access control unit may send the filtering device a message that contains a node identifier for the declined node, with the result that data traffic over the ring is blocked for this node identifier by the filtering device. In one variant embodiment, as an alternative or in addition, a warning message may be sent to further intra-device nodes. In an embodiment in which the device is a vehicle, a warning message may be sent to the vehicle driver, wherein this warning message may be emitted acoustically and/or visually. Furthermore, it is possible to generate a message that triggers an actuating procedure of a drive unit and/or a braking device, such as blocking of a start-up operation or automatic brake triggering.

The network access control unit and the interface unit may be formed at least partly, advantageously entirely by a common physical assembly. In particular, at least the first unit of the network access control unit may be formed by the interface unit. The interface unit and/or the network access control unit and at least one of the intra-ring nodes may be formed at least partly, advantageously entirely by a common physical assembly. To put it another way, the interface unit and/or the network access control unit may be formed at least partly, advantageously entirely by the advantageously cohesive assembly of an intra-ring node.

The network access control unit and the identification device may be formed at least partly, advantageously entirely by a common physical assembly. In particular, at least the first unit of the network access control unit may be formed by the identification device. Once the extra-ring node has been authenticated, the network access control unit, fulfilling the function of the identification device, may take a measure relating to a node identifier of the authenticated extra-ring node such that data communication of the node in respect of the filter function is identifiable as permitted for data communication in the ring by the node identifier. The identification device and/or the network access control unit and at least one of the intra-ring nodes may moreover be formed at least partly, advantageously entirely by a common physical assembly. To put it another way, the identification device and/or the network access control unit may be formed at least partly, advantageously entirely by the advantageously cohesive assembly of an intra-ring node. If the filtering device has filter modules that are formed by intra-ring nodes, and if the network access control unit is formed at least partly, advantageously entirely by the advantageously cohesive assembly of an intra-ring node, then the advantageous separation of the functions of the network access control unit from the function of the filtering device may avoid burdening the filter modules and thus a plurality of intra-ring nodes with an authentication task. The latter may be performed with the involvement of a single intra-ring node that forms the network access control unit.

Various properties are conceivable for the formation of the node identifier. For example, a node may be characterized by a particular transport protocol (e.g. TCP, UDP). Moreover, as a further node identifier, a port number or a VLAN ID are conceivable. Particularly advantageously, the node identifier is an identifier of a service access point of the OSI layer model, such as an IP address or a MAC address or a port number. However, a simple construction of the filtering device may be achieved if the node identifier is an identifier of the OSI data link layer. This is particularly suitable if the interface unit is to take the form of a switch. In particular, the node identifier may take the form of a MAC address. The OSI data link layer is also called “layer 2” in the art.

By way of the interface unit, a connection may be made between extra-ring nodes of different types. In particular, by way of the interface unit it is possible to connect at least one extra-ring node of the set of intra-device nodes to the ring. This is particularly advantageous if the extra-ring, intra-device node that is provided for a permanent link to the device is installed, newly configured and/or reconfigured at the time of the original construction or maintenance of the device. In particular, it may be a node that is linked to the data network by way of a so-called “plug and play auto-configuration mechanism”. In particular, a set of intra-device nodes may be connected to the ring by way of the interface unit in that the interface unit makes a connection between the ring and a bus structure to which this set of nodes is linked.

As an alternative or in addition, the interface unit serves, as an extra-ring node, to connect an extra-device node that is not linked to the device or is provided for being occasionally linked to the device. Particularly advantageously, by way of the interface unit a maintenance unit—also called a “service device”—can be connected to the ring, wherein the interface unit forms a so-called “service port”. The interface unit may be provided in general for a wired and/or wireless, radio connection of the extra-device node.

In an advantageous development of the invention, it is proposed that the filtering device should have a plurality of filter rules that are each assigned to a different operating mode of the device. This allows a high level of flexibility, in particular dynamic flexibility, to be achieved in the management of the data network. For example, the filtering device may have at least one filter rule for normal operation of the device and at least one, different, filter rule for a malfunction mode of the device. A malfunction mode may for example be triggered as a result of a message on detection of a fire. Further, a malfunction mode may be triggered by a physical fault in the data network such as a break in a line. A filter rule for a malfunction mode may in particular have less stringent requirements than in normal operation of the device, in order in particular to enable fast data traffic. This is particularly advantageous in an emergency.

Moreover, it is proposed that the filtering device should have at least one filter rule for normal operation of the device and at least one, different, filter rule for an initialization mode of the device. The term “initialization mode” should in particular be understood to mean an operating mode of the device that occurs from a switch-off mode or stop mode of the device until the start of normal operation. In the art, the initialization mode can also be called “booting” of the device. A filter rule for the initialization mode may in particular have less stringent requirements than normal operation of the device, so that normal operation may be established quickly and reliably. If the device takes the form of a vehicle, it is possible to achieve driving mode quickly and reliably as a result of at least one particular filter rule in initialization mode. As a result of the proposed solution, it is possible—in the case of the device taking the form of a rail vehicle—in particular for the phase of so-called “train set-up” to take place quickly and reliably.

A filter rule in malfunction and/or initialization mode may provide for data traffic to be filtered over at least part of the ring with minimal restriction of a node identifier. In particular, alongside a filter rule for normal operation, a second filter rule for malfunction and/or initialization mode may be provided, in which the filtering that is based on a node identifier according to the filter rule of normal operation is adjusted. In the initialization mode, it may in particular be provided for a list of the node identifiers that are authorized by the filtering device to be drawn up by logging on all the intra-device nodes. A log-on message that is required for this and is sent to the filtering device can be transmitted in and over the ring without restriction by means of the second filter rule, with further messages whereof the content goes beyond this log-on, and accordingly includes further useful data, being subject to the filter rule of normal operation. If the data network has a network access control unit, as described above, then in at least one operating mode of the device the interface unit is advantageously provided for enabling an interface for connecting to the ring an extra-ring node that is not checked by the network access control unit. As a result, in a particular operating mode, particularly advantageously in malfunction and/or initialization mode, for permission for data traffic in the ring it is possible to dispense with a pre-condition relating to a successful permission procedure by the network access control unit in respect of normal operation. Thus, if the device takes the form of a rail vehicle, it may be provided in the initialization mode thereof for data traffic in the initialization mode to take place over at least part of the ring having extra-ring nodes that have not, or not completely, been authenticated by the network access control unit. Here, an authentication grace period can be provided, during which the requirement for authentication is dispensed with but after which a required authentication procedure must be completed successfully. Once this period has expired, it can be decided to extend the waiving of the authentication requirement or to block data traffic with unauthenticated nodes.

If the device takes the form of a vehicle, in particular a rail vehicle, then normal operation may be a passenger service. The latter may include different phases, such as a travel mode and a stop mode, for which where appropriate different filter rules may be provided. Further operating modes may be, as listed above, a malfunction mode, an initialization mode or indeed a maintenance mode, in particular a workshop mode or a diagnostic mode. In maintenance mode, in particular a filter rule can be implemented that simplifies access by an extra-device node that is recognized as a service device to data traffic in the ring, by comparison with normal operation.

The operating mode may be detected by a sensor, such as a motion sensor, or it may be actively established by input by a member of the operating personnel, such as by means of a switching unit in the driver's cab for activating a maintenance mode.

According to an advantageous development of the invention, it is proposed that the identification device should have a unit for setting the identifier, which is provided in the case of an extra-ring node for assigning thereto a node identifier that is authorized by the filtering device, in particular being predefined. Here, the filtering device advantageously has a set of predefined node identifiers which, when necessary, can be assigned to an extra-ring node that is to be permitted at least temporarily. In this embodiment, the filtering device has at least a list of authorized node identifiers, which takes the form of a static or uneditable list. In this embodiment, for data traffic in the ring the extra-ring node has a node identifier from this list, wherein this node identifier may be different from a node identifier for data traffic outside the ring. In this arrangement, the unit for setting identifiers advantageously has a translation function which allows an unambiguous coupling between two node identifiers of the same extra-ring node to be made. If the ring for safety communication is used, a change to the filter rules may not be permissible, or it may not be possible to perform authentication of a node within the ring. Here, the invention may be applied particularly advantageously, since filtering that is relatively simple to realize is performed and may be checked with relatively little complexity in the case of safety permission and need not be reconfigured during operation. After successful authentication of an extra-ring node, there is assigned to the data traffic thereof a node identifier that permits communication over the ring, that is to say that is not blocked by the filter function. In a preferred variant, the filter rules for the ring are not changed here. This is particularly advantageous if the filtering device has filter modules that are formed by intra-ring nodes, so filtering takes place in the ring.

As an alternative or in addition, the identification device may be provided, for an extra-ring node, for the purpose of alerting the filtering device that a node identifier that is assigned thereto is an authorized identifier. For example, the identification device may send a message to the filtering device, this message containing an assigned node identifier of the node to be given permission. If the filtering device has a set of filter modules, the node identifier can send a so-called “multicast” or “broadcast” message to the filter modules. If the filtering device has a list of authorized node identifiers, this list can be edited by the proposed measure of the identification device, in particular can be supplemented by the already assigned node identifier of the extra-ring node that is to be permitted.

Reception and forwarding of the message by the filter modules allows the latter to be mutually notified of the node identifier of the node that is to be permitted. In an advantageous variant embodiment, it is proposed that an intra-ring node should fulfill the function of a ring manager and that the identification device should be provided for sending a message containing the node identifier to the ring manager. As a result, notifying the filter modules may be performed simply, by a communication with the ring manager.

The invention further relates to a method for managing a data network of a device, wherein the data network has a set of intra-device nodes, at least one ring in which intra-ring nodes of the set are networked to one another in a ring topology, and at least one interface unit that is provided for making a connection to the ring by at least one extra-ring node.

It is proposed that data traffic in the ring should be filtered for at least one node identifier and, for an extra-ring node, at least one measure should be taken in relation to a node identifier of this node such that this node identifier is permissible in relation to the filter function for data traffic in the ring. In respect of the advantageous effects of the method proposed, the reader is referred to the statements above on the proposed data network.

Exemplary embodiments of the invention will be explained in more detail with reference to the drawings, in which:

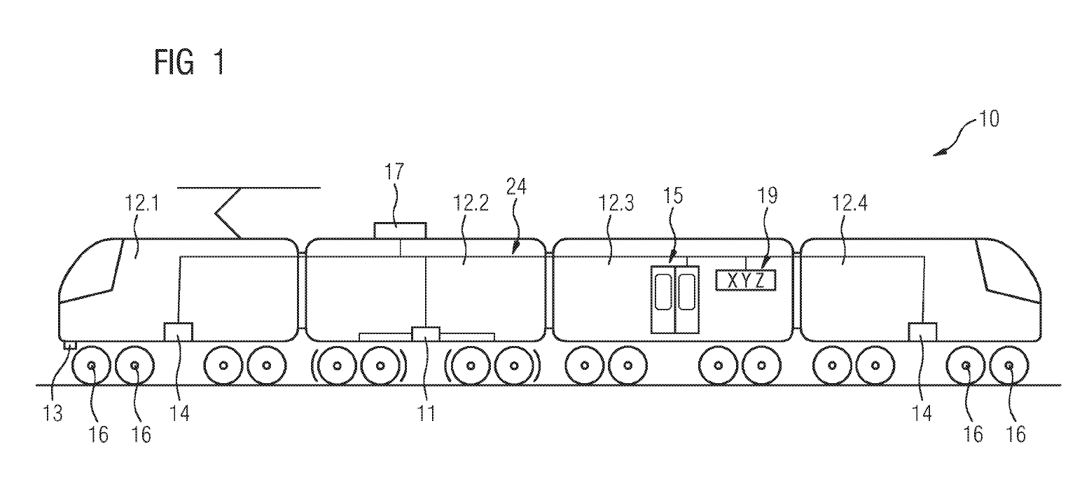

FIG. 1: shows a rail vehicle having internal functional components, in a schematic side view,

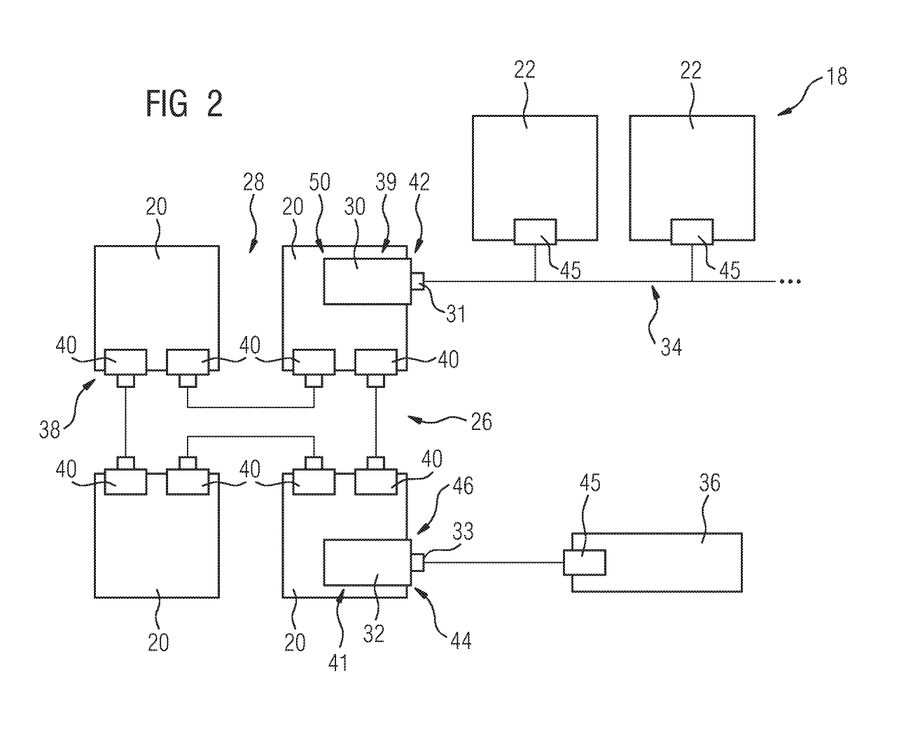

FIG. 2: shows a data network that connects the functional components and has a ring to which a filtering device is assigned,

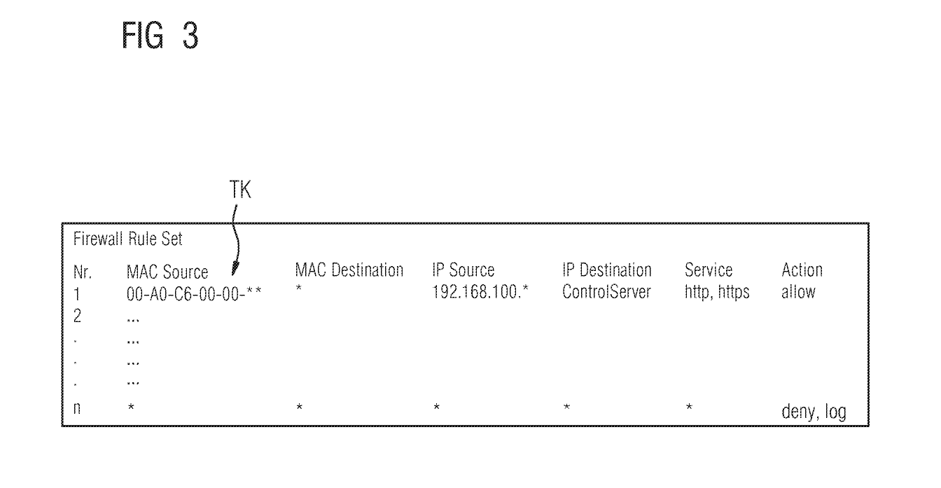

FIG. 3: shows a list of node identifiers that are permitted by the filtering device,

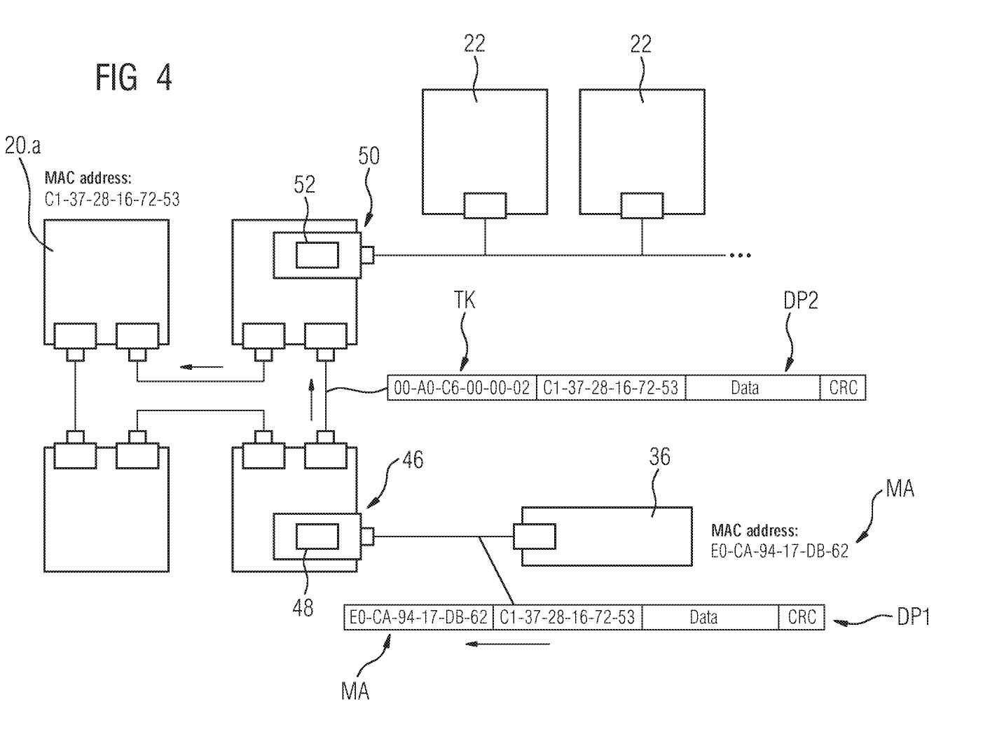

FIG. 4: shows the transmission of a data packet in the network in FIG. 2, with translation of a node identifier,

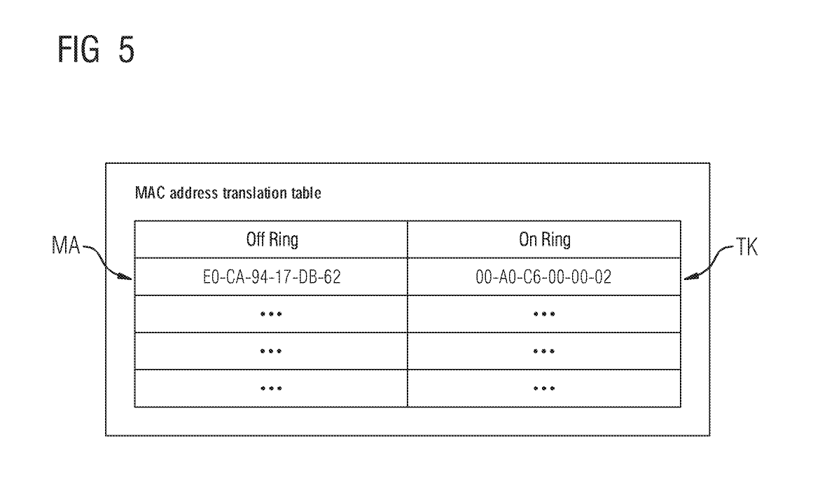

FIG. 5: shows a translation table for the translation in FIG. 4,

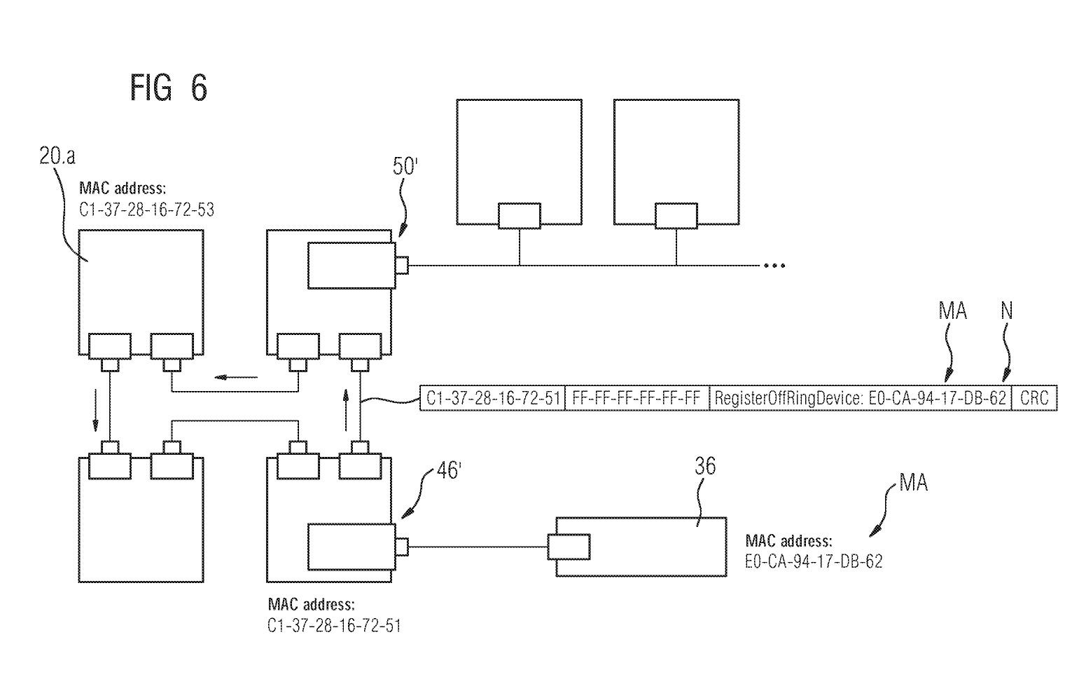

FIG. 6: shows how the filtering device is notified of a node identifier,

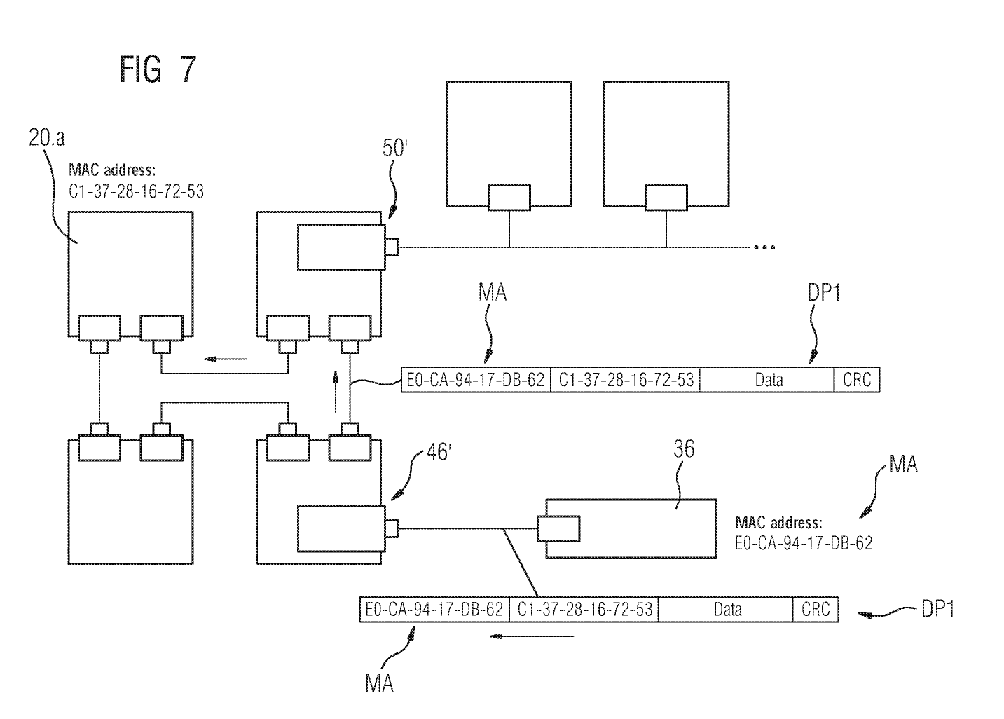

FIG. 7: shows the transmission of a data packet with the node identifier after the notification in FIG. 6,

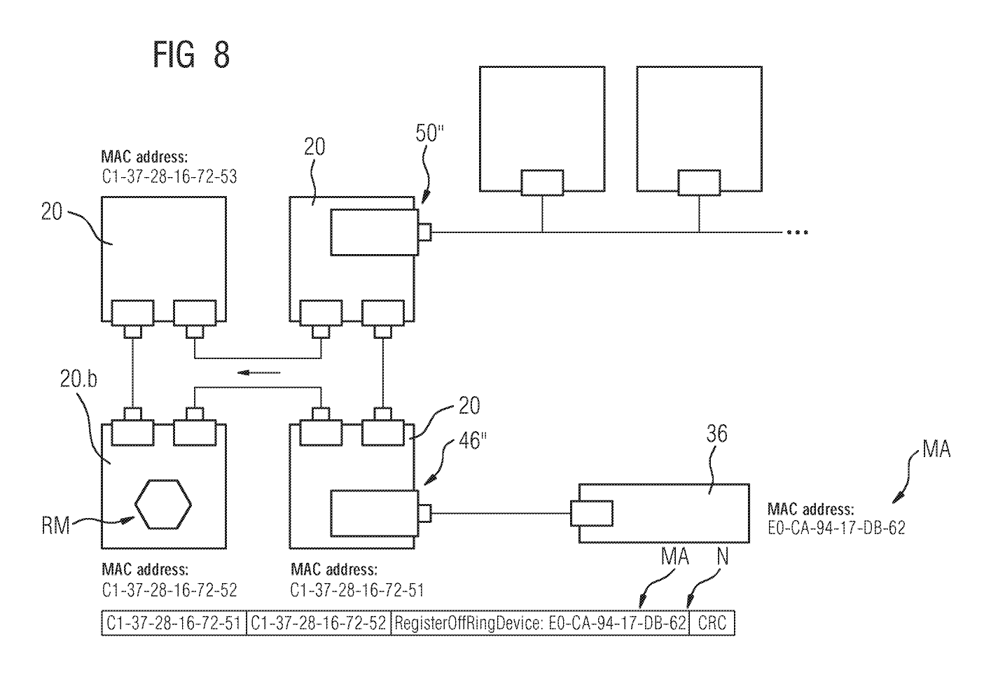

FIG. 8: shows how a ring manager of the ring is notified of a node identifier, and

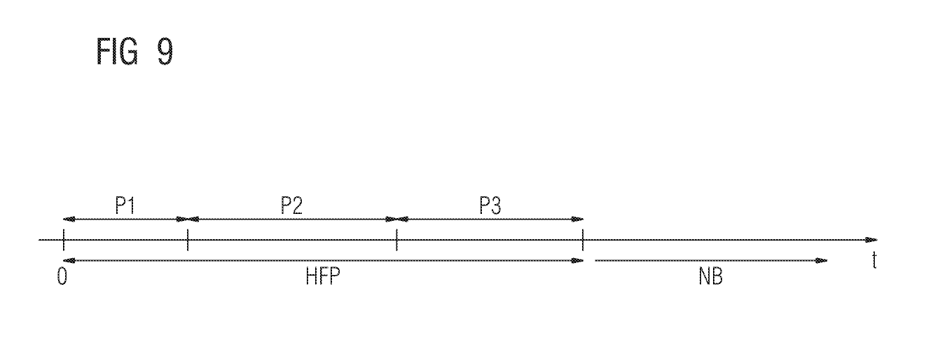

FIG. 9: shows a time sequence of an initialization mode of the rail vehicle.

FIG. 1 shows a vehicle 10 that takes the form of a rail vehicle, in a schematic side view. The vehicle 10 takes the form of a series comprising a plurality of cars 12 that are mechanically coupled to one another and form a trainset. In the embodiment under consideration, the vehicle 10 takes the form of a so-called multiple unit. For this purpose, at least one of the cars 12 of the series is provided with a drive unit 14 for driving a drive axle 16. The drive unit 14 has a power supply unit that generates electrical power for an electric motor (not shown), in particular by means of power electronics. In a further embodiment, it is conceivable for the vehicle 10 to take the form of a single railcar. Moreover, the vehicle 10 may have a series of passenger cars that have no drive, this series being coupled to at least one traction unit such as a locomotive.

As is known, the vehicle 10 has a number of functional components that make operation of the vehicle 10 possible. Typical functional components, such as in particular components of the drive unit 14, a braking device 11 (illustrated schematically and by way of example in the car 12.2), a train protection unit 13, a door unit 15 (illustrated schematically and by way of example in the car 12.3), an air conditioning unit 17, a passenger information system 19, an onboard supply system, etc. are generally known and are not explained here in more detail. Functional components of the vehicle 10 may in general take the form of a control unit, sensor unit and/or actuator unit, wherein a set of functionally cohesive functional components that are assigned to a particular functionality, such as one of the functionalities listed above, may also be called a “subsystem”. The functional components that are installed in the vehicle 10 and hence permanently linked to the vehicle structure are networked to one another and thus constituent parts of a data network 18 (see FIG. 2). From the point of view of vehicle instrumentation and control engineering, the functional components associated with the vehicle 10 are called “internal” nodes 20, 22 of the data network 18 of the vehicle 10. The internal nodes 20, 22 are connected to one another for data transfer by means of a bus device 24 that may itself have different bus structures. The bus structures may differ from one another in respect of the layout of the respective network hardware and/or a network protocol that is used.

FIG. 2 illustrates in more detail part of the data network 18. A first bus structure 26 of the bus device 24 connects the nodes 20 in a closed loop such that they form a ring 28 of the data network 18. In order to distinguish the internal nodes 20 in the ring 28 from the other internal nodes 22 of the data network 18, they are called “intra-ring nodes”, while the further nodes 22 and external nodes (see below) are called “extra-ring nodes”. In the art, the internal nodes 22 are also called “off-ring components” of the data network 18. The bus structure 26 of the ring 28 in the embodiment under consideration is based on a technology known by the term “industrial Ethernet”. The intra-ring nodes 20 in particular each take the form of a controller. For example, the intra-ring components 20 may each take the form of a PLC. The extra-ring nodes 22 are illustrated in an abstract manner in FIG. 2 and may each correspond to a particular functional component or an entire subsystem of the vehicle 10 illustrated in FIG. 1.

The data network 18 has interface units 30, 32 that can be used to connect extra-ring nodes to the ring 28. The interface unit 30 serves to connect the internal nodes 22 to the ring 28. These are themselves networked to one another by means of a bus structure 34 that is different from the bus structure 26. The interface unit 30 in this case serves to connect the bus structure 34 and the nodes 22 connected thereto to the ring 28. In an exemplary embodiment, the bus structure 34 may take the form of an MVB bus of the TCN protocol.

The interface unit 32 serves to connect an external node 36 to the ring 28. In this context, an external node is a functional component that is provided for being occasionally linked to the data network 18. For example, the external node 36 may be a portable maintenance device which, when required, is to be connected to the data network 18 for data transfer, and otherwise, in normal operation of the vehicle 10, is not connected to the data network 18. The interface unit 32 may be provided for the purpose of making a wired and/or wireless connection between the ring 28 and the external node 36.

In addition to the possibility of a physical (or hardware) connection 31 or 33, the interface units 30, 32 are each equipped at least with a switch functionality. Moreover, they are each coupled directly mechanically to an intra-ring node 20. In particular, the respective intra-ring node 20 and the coupled interface unit 30 or 32 are arranged in the same, cohesive assembly. The intra-ring nodes 20 in the embodiment under consideration in particular each take the form of a controller having a switch functionality.

The data network 18 moreover has a filtering device 38 having a filter function that is provided for filtering data traffic in the ring 28 in respect of at least one node identifier. In the embodiment under consideration, the node identifier that is taken into account for the filtering is an identifier of the OSI data link layer. In particular, for filtering purposes at least one MAC address of a node is checked using at least one filter rule. This is a node-internal or external—that takes part in data transmission that occurs or is to occur over at least part of the ring 28. The filtering device 38 has a set of filter modules 40. Data traffic over the ring 28 may occur in two directions, clockwise or counterclockwise.

A pair of filter modules 40 is assigned to each of the intra-ring nodes 20. A first filter module 40 of the pair monitors the data flow that is directed toward the node 20 for a given direction of the data traffic in the ring 28, while the second filter module 40 of the pair monitors the data flow that is directed toward the node 20 in the opposite direction of data traffic. In an alternative embodiment, data traffic may be possible in only one direction.

The filtering device 38 moreover has filter modules 39, 41 that are each assigned to an interface unit 30, 32 and are in particular coupled thereto. These filter modules 39, 41 allow data traffic directed toward the ring 28 to be filtered before data arrives in the ring 28. Moreover, the filter modules 39, 41 can filter data traffic that comes from the ring 28 and is directed toward an extra-ring node. In a particular embodiment, these additional filter modules 39, 41 may be dispensed with. The description below relates to the filter modules 40 and is also accordingly applicable to the filter modules 39, 41.

The filtering device 38 is programmed with a first filter rule that performs monitoring of data packets that are or are to be transmitted over at least part of the ring 28. As described above, monitoring is carried out on the basis of a node identifier that corresponds to the MAC address of a node that takes part in transmission of a data packet. This may be the node that takes the form of a transmitter and/or the node that takes the form of a receiver of the packet. The filter modules 40 which are assigned to the intra-ring nodes 20 perform filtering of the data traffic that occurs over at least part of the ring 28, in that a data packet directed toward the respective node 20 is only forwarded by this node 20 if the node identifier or identifiers that are to be monitored in this data packet by the filter rule appears or appear in a list of permitted node identifiers. This list is illustrated in FIG. 3. As the filter rules, it is moreover possible to implement further rules that correspond to conventional firewall rules.

The filter modules 40 are each formed by a device having a switch functionality. Here, they may be formed by a separate switch that is constructed separately from the assigned intra-ring node 20. In the embodiment under consideration, however, they are each coupled directly mechanically to the assigned intra-ring node 20. In particular, the respective intra-ring node 20 and the assigned filter module 40 are arranged in the same, cohesive assembly. The intra-ring nodes 20 in the embodiment under consideration in particular each take the form of a controller having a switch functionality.

The data network 18 further has network access control units 42, 44 that are respectively assigned to a different interface unit 30 or 32. They each serve to manage, in particular to permit or deny, data traffic access to the ring 28 for extra-ring nodes 22 and 36 respectively, in accordance with a defined authentication protocol. If data traffic access is permitted to the extra-ring node, it may take part in data transmission over at least part of the ring 28. Once authentication of an extra-ring node 22, 36 by the network access control unit 42 or 44 has come to a successful conclusion with permission, an interface (also called a “port”) of the assigned interface unit 30 or 32 is enabled for access by the extra-ring node to the ring 28.

The authentication protocol may be for example a protocol according to IEEE 802.1x, such as in particular in the form of an EAP TLS authentication using a device certificate.

The functions of the network access control units 42, 44 and the filtering device 38 will first be explained by way of the example of connecting an external node 36.

Data traffic access for the external node 36, which is occasionally linked to the data network 18 as a maintenance device, is managed by means of the network access control unit 44. Once a wired or wireless data connection has been made between the external node 36 and the interface unit 32, authentication of the node 36 by means of the assigned network access control unit 44 takes place in accordance with a protocol of the above-mentioned type. For this purpose, for example an authentication module 45 (or “authenticator”) is provided, and this is implemented in each of the extra-ring nodes 22, 36 and cooperates with the corresponding network access control unit 42 or 44. If the external node 36 is successfully authenticated in relation to the network access control unit 44, then data traffic that takes place over an enabled port of the assigned interface unit 32 and at least part of the ring 28 and in which the external node 36 takes part is considered permitted. The network access control units 42, 44 are each equipped with a switch functionality and may each take the form of a so-called “access switch”.

So that this data traffic is also permitted in relation to the above-described filter function of the filtering device 38, corresponding measures should be taken. For this purpose, an identification device 46 is assigned to the interface unit 32. The identification device 46 serves to take a measure in relation to a node identifier of the external node 36, with the result that the node identifier that is used in the ring 28 in the event of data transmission from the external node 36 is permitted according to the applicable filter rule. A number of variants are possible for this.

According to a first variant that is shown in FIG. 4, the identification device 46 has a unit 48 for setting an identifier, and this is provided for assigning to the external node 36 a node identifier TK that is authorized by the filtering device 38. For this purpose, in the above-mentioned list shown in FIG. 3 at least one identifier TK appears, in the embodiment under consideration a MAC address, which if required may be assigned to an external node 36. This identifier is a so-called “free” identifier which has not been in use before the external node 36 is added into the data network 18. In order to set a node identifier TK that is permitted in relation to the filtering device 38, the unit 48 preferably has a translation function. For this purpose, the unit 48 generates a translation table, shown in FIG. 5, which an unambiguous relationship between the actual node identifier, in particular MAC address MA, of the extra-ring node 36 that is to be linked, and a free node identifier TK that is entered in the list of the filtering device 38. This may be called a “MAC address translation table” in the art.

FIG. 4 illustrates a data packet DP1 that has been generated by the external node 36 and is addressed to the intra-ring node 20.a that is illustrated top left in the figure. The identification device 46, which receives the data packet DP1, uses the unit 48 to replace the origin address, that is to say the node identifier MA that takes the form of a MAC address, by a free node identifier TK from the list shown in FIG. 3. The data packet DP2 that is forwarded by the identification device 46 now contains this node identifier TK as the origin address. Since this node identifier TK is permitted by the filtering device 38, that is to say by the filter modules 40, the data packet DP2 is forwarded to the receiver (node 20.a).

Correspondingly, in the case of a data communication that is directed toward the external node 36, the node identifier that is used in the ring 28 as the permitted node identifier TK of the destination is translated back into the actual node identifier MA of the external node 36 by the unit 48 for identification setting, according to the translation table shown in FIG. 5. It is possible that the node identifier for a data communication that is made over the ring 28 between the external node 36 and an internal node 22 will be translated twice.

Variant embodiments are shown in FIGS. 6 and 8. In these embodiments, the actual node identifier MA of the external node 36 is used for taking part in data traffic over at least a part of the ring 28. In particular, the MAC address of the external node 36 is used as the node identifier MA for this data traffic. So that this can happen without its being filtered out by the filtering device 38, the node identifier MA that has already been assigned to the external node 36 must be made known to the filter modules 40 as an identifier that has been authorized in respect of the relevant filter rule. Accordingly, in the variant embodiments considered, the list shown in FIG. 3 undergoes an updating procedure with the node identifiers that are permitted by the filtering device 38. The updating procedure is initialized by the identification device. For this, at least two procedures are possible. To distinguish between the variant embodiments, the reference numerals 46′ and 46″ for the identification device are used.

In the variant according to FIG. 6, the identification device 46′ sends a message N to the ring 28 such that all the filter modules 40—that is to say, in the embodiment of the filtering device 38 that is concretely being considered—all the intra-ring nodes 20 receive this message N. This message N contains the node identifier MA of the external node 36 that is to be permitted, as shown in the figure. Once the message N has been received, the filter modules 40 each expand their list of node identifiers to be permitted to include the node identifier MA of the external node 36. The message N is preferably sent by the identification device 46′ as a multicast or broadcast message. The message N is sent in the form of a data packet, with the MAC address of the identification device 46′ as the origin address and—in the embodiment under consideration—the address provided for broadcast, FF-FF-FF-FF-FF-FF as the destination address. The information content of the message N includes a command (“RegisterOffRingDevice”) that the list of node identifiers to be permitted is to be expanded by the node identifier MA by the filter modules 40 that are addressed.

FIG. 7 shows the transmission of the data packet DP1, which is forwarded, unchanged, by the filter modules 40 that are arranged on the transmission path to the receiver (node 20.a). In contrast to FIG. 4, the data packet DP1 contains as the origin address the actual node identifier MA of the external node 36, which was entered in the list in FIG. 3 by means of the above-described measure performed by the identification device 46′.

In the variant according to FIG. 8, the ring 28 has a so-called ring manager RM. The latter is formed by one of the intra-ring nodes 20, which has certain management functions in relation to the other intra-ring nodes 20. The identification device 46″ sends the message N to the ring manager RM, which on receiving it triggers an updating procedure of the lists of node identifiers permitted by the filter modules 40. The ring manager RM distributes the information, for example by sending a multicast or broadcast message or by individual addressing of the filter modules 40. Data traffic may then proceed as shown in FIG. 7.

The message N in both variant embodiments may be called a “FilterUpdate message” in the art. It is preferably sent in encrypted form. In particular, it may have a cryptographic checksum, for example according to AES-CBC-MAC, HMAC-SHA1, HMAC-SHA256, RSA signature, DSA signature or ECDSA signature.

In the embodiments described above, the filtering device 38 has a filter rule that filters the data traffic in respect of at least one node identifier. Data traffic over at least part of the ring 28 is only permitted if the corresponding data packets contain node identifiers that appear in the list according to FIG. 3. If this is not the case, a data packet is blocked by a filter module 40 and is not forwarded to the next intra-ring node 20. The measure that is taken by the identification device 46, 46′ or 46″ in relation to a node identifier is accordingly only taken if the extra-ring node 36 could be successfully authenticated at the network access control unit 44. Whether the measures by the identification device 46, 46′ or 46″ that are described above are taken accordingly depends on the permission of the external node 36 by the network access control unit 44.

The functions of the network access control units 42, 44 and the identification device 46, 46′ and 46″ were explained above with reference to the example of the network access control unit 44, which is used for connecting external nodes such as the external node 36.

The network access control unit 42 is used for connecting extra-ring nodes that take the form of internal nodes 22 or are newly installed in the vehicle 10, or after start-up are installed therein again. It is assigned to the interface unit 30. As was explained in relation to the network access control unit 44, a node identifier 50 is assigned to the interface unit 30. For a description of the functioning of the network access control unit 42 and the identification device 50, the reader is referred to the text above on the corresponding network access control unit 44 and the identification device 46. Similarly to the identification device 46, this latter device has in the first variant embodiment, which is shown in FIG. 4, a unit 52 for setting identifiers, whereof the functioning is identical to the functioning of the unit 48. In the variant embodiments according to FIGS. 6 and 8, the reference numerals 50′ and 50″ are used, for the purpose of making a distinction.

The interface unit 30 and, assigned thereto, the network access control unit 42 and the identification device 50 may be formed as mutually separate assemblies. However, as in the embodiment under consideration, it is advantageous if they are constituent parts of a common, cohesive assembly. In particular, this assembly corresponds to one of the intra-ring nodes 20, as can be seen in the figures. Here, the intra-ring node 20 includes the interface unit 30 and the assigned network access control unit 42 and identification device 50. In this context, it may be programmed with the functions of these devices. The statements above also apply to the interface unit 32 and the assigned network access control unit 44 and identification device 46.

In the embodiment under consideration, the filtering device 38 has a plurality of filter rules that are each assigned to a different operating mode of the vehicle 10.

For example, it may be necessary for data communication that takes place over at least part of the ring 28 to be managed such that the functional components connected to the data network 18, or the internal nodes 22, can be booted up within a short period. For this purpose, during this boot phase of the vehicle 10 there applies a filter rule that has been modified, by comparison with the above-described filter rule in normal operation. Moreover, during the boot phase at least the network access control unit 42 is operated in an operating mode that differs from the above-described operating mode that is applied in normal operation of the vehicle 10.

This is illustrated in FIG. 9. For the network access control unit 42 and the filtering device 38, a so-called grace period is implemented, during which less stringent requirements apply than in normal operation. In the embodiment of the device as a vehicle 10 that is under consideration, normal operation corresponds to a “regular driving mode”. This is not enabled until authentication of all the internal nodes 20, 22 by the network access control unit 42 has been successfully completed.

During the boot phase HFP (see FIG. 9), the filter rule of the filtering device 38 that is described in normal operation of the vehicle 10, defined using the list of permitted node identifiers, is disabled. Accordingly, a second filter rule of the filtering device 38 applies, according to which any data traffic over at least part of the ring 28 is permitted by the filtering device 38. As a result, data traffic over the ring 28 that is required in particular for constructing the data network 18 and for authenticating the internal nodes 20, 22 can take place without restriction by the filter modules 40. The boot phase HFP can be divided into a plurality of phases. In a first phase P1, the data network 18 is constructed. In a further, subsequent phase P2, data communication between one of the internal nodes 20, 22, which has the function of a central controller, and the internal nodes 20, 22 assigned to it is initialized. This controller may take the form for example of an extra-ring node 22. This step corresponds to an initialization of the control network that is controlled by the central controller.

In the first phases P1 and P2, the network access control unit 42 and the filtering device 38 are operated such that the internal nodes 20, 22 are permitted to take part in data traffic over the ring 28 despite not having yet been subject to authentication by the network access control unit 42. During this, in particular it is possible to connect all the extra-ring nodes 22 to the ring 28 by way of at least one interface (or port) of the interface unit 30, wherein this interface of the interface unit 30 is enabled despite the fact that the extra-ring nodes 22 have not yet all been checked by the assigned network access control unit 42, or checking thereof has not yet been concluded.

Once phase P2 has ended, the above-described authentication procedures of the internal nodes, that is to say the intra-ring nodes 20 and the extra-ring nodes 22, are performed by the network access control unit 42 during a phase P3 according to one of the above-described authentication protocols, in particular by means of a certificate-based authentication. Once the authentication procedures have been successfully concluded, the boot phase HFP ends, and with it the grace period of the filtering device 38. In the subsequent normal operation NB that is released, in particular the regular driving mode, the filter rule that was explained above applies on the basis of the node identifiers. The boot phase HFP is also called the “initialization mode” of the vehicle 10. In the embodiment of the vehicle 10 that is under consideration, as a rail vehicle, the so-called “train set-up” is in particular performed during the initialization mode.

The operating mode of the network access control unit 42 and the filtering device 38 that is used in initialization mode may moreover be activated if operation of the vehicle 10 has malfunctioned. Operation of this kind may for example be activated by triggering an emergency brake signal or by a fire alert.

Further operating modes are conceivable for which a different filter and/or authentication rule is provided from that in normal operation of the vehicle 10. For example, in particular in a maintenance mode or a manufacturer's workshop mode, a filter rule may be provided that corresponds to the second filter rule. In these modes, data traffic over at least part of the ring 28 is accordingly possible without restriction.

It is moreover also conceivable for a filter rule of the filtering device 38 and/or the authentication procedure of the network access control units 42, 44 to be reconfigurable in normal operation, that is to say in the example under consideration in regular driving mode, or to put it another way to be blocked for the purpose of reconfiguration. This block may be lifted for example when a further operating mode is activated, for example maintenance mode.

Data traffic over at least part of the ring 28 may be blocked explicitly in normal operation for a particular external node that has already successfully undergone authentication in the data network 18 at least once, by a filter rule of the filtering device 38 and/or operating mode of the network access control unit 44. For example, in regular driving mode of the vehicle 10, data traffic with the external node 36 which has nonetheless successfully undergone authentication in a previous maintenance mode may be blocked by the filtering device 38 and/or the network access control unit 44.

In the embodiments shown in the figures, data traffic may take place in the ring 28 in different directions, that is to say clockwise or counterclockwise. This makes potential transmission paths of different lengths possible, it being preferable for the transmission path having the shortest length to be selected for data traffic. It is moreover also possible for one of the intra-ring nodes 20 to implement the function of a master (or “media redundancy master switch”) that logically interrupts the ring 28 at a particular location.

In a preferred variant, the filter rules of the filtering device 38 are independent of the direction of transmission of a data packet. This has the advantage that, if the ring is reconfigured, in particular because of a fault, there is no need for reconfiguration of the filter rules. However, filter rules of the filtering device 38 may also be provided for filtering data packets that are dependent on the direction of transmission of a data packet over the ring 28. According to a filter rule, it may be provided for a filter module 40 for a data packet to be forwarded only in a particular direction and to be blocked in the opposite direction. In this case, an automatic reconfiguration of the filter rules for the intra-ring nodes 20 may be performed in order to take into account the different transmission direction. In another variant, no automatic reconfiguration of the filter rules is performed. In this case, the internal nodes 20, 22 have to be authenticated again so that suitable filter inputs can then be set up.

In a further variant, automatic reconfiguration of the filter rules is performed for the intra-ring nodes 20, whereas the extra-ring nodes 22 have to be authenticated again.

1-18. (canceled)

19. A data network of a device, the network comprising:
a set of a plurality of intra-device nodes;
at least one ring in which intra-ring nodes of said set are networked to one another in a ring topology;
at least one interface unit configured for establishing a connection of at least one extra-ring node to said ring;
a filtering device having at least one filter function and being configured for filtering data traffic in said ring for at least one node identifier; and
an identification device configured for taking, for an extra-ring node, at least one measure relating to a node identifier of the extra-ring node such that the node identifier is permitted in respect of the filter function for data traffic in said ring.

20. The data network according to claim 19, wherein said filtering device comprises a set of a plurality of filter modules, wherein at least one different said filter module is assigned to each of said intra-ring nodes.

21. The data network according to claim 20, wherein at least one different filter module is connected to each of said intra-ring nodes.

22. The data network according to claim 19, wherein said filtering device includes at least one filter module that is equipped with a switch functionality.

23. The data network according to claim 19, wherein each of said intra-ring nodes is a controller.

24. The data network according to claim 19, which further comprises:
a network access control unit programmed for managing data traffic access according to a defined authentication protocol; and
wherein said identification device is configured, in at least one operating mode, for taking the measure for an extra-ring node as a function of whether the extra-ring node is permitted by said network access control unit.

25. The data network according to claim 19, wherein the node identifier is an identifier of an OSI (open systems interconnection) data link layer.

26. The data network according to claim 19, wherein said interface unit is configured to connect at least one extra-ring node of said set of intra-device nodes to said ring.

27. The data network according to claim 19, wherein said interface unit serves, as an extra-ring node, to connect an extra-device node that is not linked to the device or is occasionally linked to the device.

28. The data network according to claim 19, wherein said filtering device has a plurality of filter rules that are each assigned to a different operating mode of the device.

29. The data network according to claim 28, wherein said filtering device has at least one filter rule for normal operation of the device and at least one filter rule, different from the at least one filter rule for normal operation, for an initialization mode of the device.

30. The data network according to claim 24, wherein, in at least one operating mode of the device, said interface unit is configured to enable an interface for connecting to the ring an extra-ring node that is not checked by said network access control unit.

31. The data network according to claim 19, wherein said identification device includes a unit for setting the identifier, which is provided in the case of an extra-ring node for assigning thereto a node identifier that is authorized by said filtering device.

32. The data network according to claim 19, wherein said identification device is configured, for an extra-ring node, to alert said filtering device that a node identifier that is assigned thereto is an authorized identifier.

33. The data network according to claim 32, wherein said identification device is configured for sending a message containing the node identifier to the filtering device.

34. The data network according to claim 32, wherein one of said intra-ring nodes is configured to fulfill a function of a ring manager and said identification device is configured for sending a message containing the node identifier to said ring manager.

35. A vehicle, comprising a data network according to claim 19.

36. The vehicle according to claim 35 being a rail vehicle equipped with the data network.

37. A method of managing a data network of a device, the data network having a set of intra-device nodes, at least one ring in which intra-ring nodes of the set are networked to one another in a ring topology, and at least one interface unit configured for connecting at least one extra-ring node to the ring, the method comprising:
filtering data traffic in the ring for at least one node identifier; and
for an extra-ring node, taking at least one measure in relation to a node identifier of the extra-ring node to render the node identifier permissible in relation to the filter function for data traffic in the ring.
